(19) United States
(12) Patent Application Publication
(10) Pub. No.: US 2022/0268656 A1
(43) Pub. Date: Aug. 25, 2022

(54) Wireless Pitot Gauge Transducer

(71) Applicant: Joseph John D'Antoni, III, Baltimore, MD (US)

(72) Inventor: Joseph John D'Antoni, III, Baltimore, MD (US)

(21) Appl. No.: 17/354,887

(22) Filed: Jun. 22, 2021

Related U.S. Application Data
(60) Provisional application No. 63/152,563, filed on Feb. 23, 2021.

(51) Int. Cl. G01L 19/08; G01L 19/12; G01L 19/00

(52) U.S. Cl. CPC G01L 19/086; G01L 19/12; G01L 19/0038

(57) ABSTRACT

This present invention relates to a wireless pitot gauge having a pressure transducer or transmitter to record pressure readings and transmit the readings to an electronic device. The gauge attaches to a hose, pipe or conduit which connects to a water pump or inlet like a standpipe on a commercial building. The gauge has a pressure transducer and transmitter that transmits the pressure reading to an electronic device via a mobile application. The wireless pitot gauge of the present invention is useful to measure water flows from fire hose nozzles, fire hydrants, and other water-based systems.

### CROSS-REFERENCE TO RELATED APPLICATION

The present application claims priority to, and the benefit of, U.S. Provisional Application No. 63/152,563, which was filed on Feb. 23, 2021 and is incorporated herein by reference in its entirety.

### FIELD OF THE INVENTION

The present invention relates generally to the field of pressure measurement devices or gauges. More specifically, the present invention relates to a wireless pitot gauge transducer which is designed to generate real-time pressure readings of the water system in a building, compartment or venue, and transmit the measured readings to a paired electronic device which may be remote from the location where the pitot is installed. The wireless pitot gauge transducer of the present invention eliminates the need to open and close the various valves for switching back and forth from tubes to read pressure, and therefore saves the time and effort for the users. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, water-supply systems deliver portable water to buildings, compartments or venues, such as residential homes, commercial installations and other industrial complexes. The water can be delivered through industrial or other heavy-rated pipes capable of withstanding significant pressure created through the use of a system of high-pressure pumps. At the interface between the utility and the target building, area or venue, a pressure regulator can be installed to ensure that utility-supplied water pressure is reduced to desirable levels for appliances and/or human activity or use. The pressure of the water within the building or venue varies as water is used or as leaks occur in the plumbing or fixtures of the building or venue. Leaks in supply lines can lead to loss of water, gas or other substances, and also can reduce pressure to the ultimate source where the fluid or material is to be dispensed. Without a proper pressure reading system, there are longer flow times and greater consumption rates and losses.

Various pressure-measuring instruments such as analog pressure gauges, digital pressure gauges and others exist in the state of the art. The analog pressure gauges have a needle that directly responds to changes by pointing to numbers on a scale that corresponds to the pressure sensed by the measuring element. While taking the readings manually, there is a chance of reading inaccurate pressure readings.

The digital pressure gauges which are available in the state of the art and are designed to sense the pressure from a liquid or other fluid such as gas, propane, diesel, biofuels and the like, provide a direct reading of that pressure value on a digital display. The digital pressure gauge does not require the operator to read a value according to the position of a needle on a pressure scale, as is required in the case of analog pressure gauges. However, the operators may not be able to get the pressure readings in real-time, regardless of whether the gauge is displayed in a digital or analog format, a user must still be present to read the information displayed on the gauge.

Typically, pressure transducers, often called pressure transmitters, include a transducer that converts pressure into an analog electrical signal which is displayed by the pressure gauges. Although there are various types of pressure transducers, one of the most common is the strain-gauge base transducer. The conversion of pressure into an electrical signal is achieved by the physical deformation of strain gages which are bonded to a diaphragm on the pressure transducer and wired into a “wheatstone” or other bridge configuration. Thus, as the strain varies, the output voltage from the transducer also varies proportionately. Pressure transducers in the prior art have ¼ valves that need to be opened and closed to read the real-time pressure readings. This leads to unnecessary time and effort spent in obtaining the real-time pressure readings. and more equipment can be required. In addition, the readings are not received quickly or in a real-time format. Additionally, existing pressure transducers in the market that use a wire laying mode to gather pressure signals have certain shortcomings, such as the pressure sensor signal transmission is inconvenient, there can be difficulty in installation, cost may be high and many other issues, when the distance and environment between the location to read the pressure and the individual that is required to travel to such location is comparatively great when compared with taking the information in an office environment.

Therefore, there exists a long felt need in the art for a pitot gauge transducer that allows the users to measure the pressure in real-time, without having to travel to the location where the gauges are located, and that transmits the real time pressure readings to the electronic devices of the users and makes the pressure readings readily accessible to them. There is also a long felt need in the art for a pitot gauge transducer that eliminates the need to open and close the valves to measure the water or other fluid flow pressure through the pipelines to a building, complex, area or venue. Further, there is a long felt need in the art for a pitot gauge device that saves time for the users, and that provides an accurate measurement of pressure without having to manually read the gauges or other displays. Finally, there is a long felt need in the art for a pitot gauge transducer that eliminates the need to open and close valves for switching back and forth from the tubes to read pressure, and saves the unnecessary time and money spent in obtaining pressure readings by having to travel to different locations to read the gauges in person.

The subject matter disclosed and claimed herein, in one embodiment thereof, comprises a wireless pitot gauge that is designed to record pressure readings and transmit to a software application installed on an electronic device. The wireless pitot gauge includes a ¼″ wireless pressure transmitter, a pressure sensor and a pitot tube. The pressure sensor senses the pressure exerted by the water or other fluid flowing through the pitot tube, and the wireless pressure transmitter connects with the electronic device and transmits the real-time pressure data to the software application installed on the electronic device. The wireless pitot gauge measures up to 300 psi of water or other fluid pressure. The software application displays the real-time pressure readings in various pressure scales and graphs. The wireless pitot gauge attaches to a hose, which connects to a water pump on a commercial building or other facility where the data is to be collected.

In this manner, the wireless pitot gauge transducer of the present invention accomplishes all of the forgoing objectives, by providing a relatively quick, convenient and cost-effective solution to measure water pressure in pipelines, conduits, hoses and other supply sources. The wireless pitot gauge transducer eliminates the need to manually open and close valves for switching back and forth between tubes in order to read pressure, and saves the unnecessary time and effort spent in obtaining pressure readings at various locations. Additionally, the wireless pitot gauge transducer is a user-friendly device as it allows wireless transmission of measured pressure readings to any paired or other synched device with installed companion software application.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a wireless pitot gauge designed to record pressure readings and transmit to a software application installed on an electronic device. The device includes a ¼″ wireless pressure transmitter, a pressure sensor and a pitot tube. The pressure sensor senses the pressure exerted by the water or other fluid flowing through the pitot tube. The wireless pressure transmitter connects with the electronic device and transmits the real-time pressure reading information to a software application that has been previously installed on an electronic device, and the wireless pitot gauge measures up to 300 psi water pressure. The software application displays the real-time pressure readings in various pressure scales and graphs. The wireless pitot gauge attaches to a hose, which attaches to a water pump on a commercial building or other facility where pressure readings are required or otherwise desirable.

In a further embodiment of the present invention, a method of recording water pressure readings flowing through a valve and transmitting the readings wirelessly to a mobile device is disclosed and comprises the steps of initially installing a companion software application on a mobile device, and then attaching a ¼ pressure transducer or transmitter to a hose. Next, the ¼″ pressure transducer or transmitter is connected to the mobile device using a wireless transmitter, and the water pressure readings flowing through the valve are recorded. The recorded values are transmitted to the paired mobile device in real time, and the recorded values are displayed in a graphical and textual format by the software application for easy viewing and analysis. This method saves time and effort by providing a report to give to users and their customers which provides data to retain for their records. The software application can receive pressure readings from up to four transducers attached to four different hoses, conduits or pipes wherein each hose, conduit or pipe is connected to a separate water outlet valve.

The wireless pitot gauge of the present invention is useful in its ability to measure water and other fluid flowing from fire hose nozzles, fire hydrants and other water-based systems as well as other fluid-delivery systems including fuel, natural gas such as propane and the like. The gauge is IP65 approved and electronic components are sealed with a sealing tape. The wireless pitot gauge for water and other fluid flow tests is an accurate, efficient and economical way to measure discharge pressure from fire hose nozzles, fire hydrants or other devices which may be opened on demand.

The software application used in the present invention may have a plurality of integrated conversion formulae such as a PSI to GPM converter to provide users the readings in various units with a reasonably accurate estimation of actual flow rates. The gauge may have an internal 0-300 PSI dial range, which is connected to the wireless transducer to transmit the readings to a mobile device. The dial range measures accurate pressure for different nozzles, hydrants and pumps, as well as different water supply systems and other fluid delivery systems.

In yet a further embodiment of the present invention, a wireless pitot gauge transducer in the form of a ¼ pressure transducer, which is designed to provide real-time pressure readings and transmit the readings to a mobile device is disclosed. The wireless pitot gauge transducer can be attached to a hose, conduit or pipe, which connects to a water pump on a commercial building or other facility where such measurements are necessary for measuring real-time pressure readings on one or more of the valves on the building or facility. More specifically, the wireless pitot gauge transducer is constructed from a steel or plastic waterproof ¼ pressure transducer or transmitter, that transmits the pressure reading to a smart device via a mobile application. The wireless pitot gauge transducer can be attached to up to four hoses, pipes or conduits that are attached to the four different water or fluid outlet valves, and then each transducer can be used to send readings.

The advantage of the wireless pressure transducer of the present invention is that it includes a wireless transducer or transmitter to send pressure readings to a mobile phone, and multiple readings can be reviewed at once. The device saves time and effort by providing a report to give to customers or retain for the records of the building or facility. The device eliminates the need to repeatedly open and close valves for switching back and forth from tubes in order to read pressure. A wide pressure range between 0-300 psi can be easily measured using the wireless pressure gauge of the present invention.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the wireless pitot gauge transducer of the present invention in accordance with the disclosed architecture, wherein the wireless pitot gauge transducer is used to measure and transmit real-time pressure readings;

FIG. 2 illustrates a schematic diagram of the connection between one potential embodiment of the wireless pitot gauge transducer of the present invention and a companion mobile application installed on an electronic device in accordance with the disclosed architecture;

FIG. 3 illustrates a schematic diagram of various exemplary components of one potential embodiment of the wireless pitot gauge transducer of the present invention in accordance with the disclosed architecture;

FIG. 4 illustrates a flow diagram showing one potential method of using the wireless pitot gauge transducer of the present invention to generate an alert containing pressure or other readings in accordance with the disclosed architecture;

FIG. 5 illustrates a flow diagram showing one potential method of receiving pressure or other readings from the wireless pitot gauge transducer of the present invention in accordance with the disclosed architecture;

FIG. 6 illustrates a schematic diagram of a graphical user interface of a mobile application on an electronic device in communication with one potential embodiment of the wireless pitot gauge transducer of the present invention in accordance with the disclosed architecture;

FIG. 7 illustrates a perspective view of one potential embodiment of the wireless pitot gauge transducer of the present invention in accordance with the disclosed architecture, wherein the wireless pitot gauge transducer is being used to gather and display real-time pressure readings from a line; and

FIG. 8 illustrates a perspective view of one potential embodiment of a plurality of wireless pitot gauge transducers of the present invention in accordance with the disclosed architecture, wherein the wireless pitot gauge transducers are being used to gather and display real-time pressure and other readings from a corresponding number of lines.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a pitot gauge transducer that allows the users to measure the pressure in real-time with the ability to be remote from the pipes, conduits or hoses being measured. There exists a long felt need in the art for a pitot gauge device which transmits the real-time pressure readings to the electronic devices of the users, and makes the pressure readings readily accessible to them. There is also a long felt need in the art for a pitot gauge transducer that eliminates the need to manually open and close the individual valves to measure the water flow pressure through the pipelines and other conduits to a building, complex or venue. Further, there is a long felt need in the art for a pitot gauge device which saves time and effort, and provides for the convenience of the users. Furthermore, there is also a long felt need in the art for a pitot gauge which provides accurate measurement of pressure. Finally, there is a long felt need in the art for a pitot gauge transducer that eliminates the need to manually open and close valves for switching back and forth from tubes, conduits, pipes and hoses to read the pressure of each source, and saves the unnecessary time and effort spent in obtaining pressure readings compared with conventional processes.

The present invention, in one exemplary embodiment, is a novel a wireless pitot gauge designed to record pressure readings and transmit to a software application installed on an electronic device comprising a ¼ wireless pressure transmitter, a pressure sensor and a pitot tube. The pressure sensor senses the pressure exerted by the water or other fluid flowing through the pitot tube. The wireless pressure transmitter connects with the electronic device and transmits the real-time pressure reading information to the software application installed on the electronic device. The wireless pitot gauge measures up to 300 psi water or other fluid pressure. The software application displays the real-time pressure readings in various pressure scales and graphs, depending on the requirements of the utility or building. The wireless pitot gauge attaches to a hose, pipe, tube or conduit, which attaches to a water or other fluid pump on a commercial building such as a standpipe or other configuration.

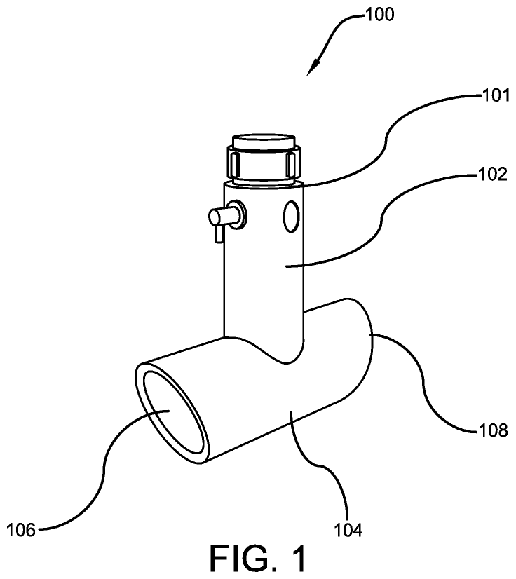

Referring initially to the drawings, FIG. 1 illustrates a perspective view of one potential embodiment of the wireless pitot gauge transducer 100 of the present invention in accordance with the disclosed architecture, wherein the wireless pitot gauge transducer 100 is measured and transmits real-time pressure readings. As noted above, taking pressure readings of water or other fluid lines is particularly important in a multi-story building in order to maintain stable water or other fluid pressure on each floor of the building. The wireless pitot gauge transducer or fluid pressure gauge 100 of the present invention is constructed from a steel or plastic waterproof ¼″ housing, which includes a pressure transducer that is designed to generate a real time pressure reading of the water or other fluid system in a building, complex or a venue. The water pressure transducer 100 is a device that measures the pressure of a fluid such as water, heating oil, propane, coolant or the like, indicating the force that the fluid is exerting on the surfaces with which it contacts. The pressure transducer 100 converts a pressure reading into an analog electrical signal, and is used in many control and monitoring applications such as flow, air speed, level, pump systems or altitude.

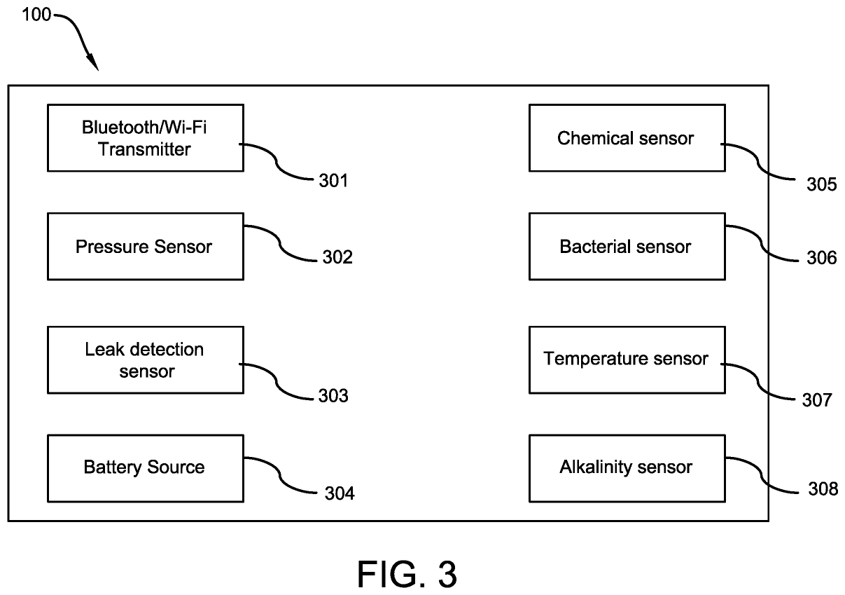

The pitot gauge transducer 100 has a vertical pitot tube 102 and a horizontal pitot tube 104 which are disposed generally at right angles to one another, however other angular configurations such as 30°, 45° and 60° angular configurations would be available to meet the particular configuration required for the building where the measurement is to occur. The vertical pitot tube 102 and the horizontal pitot 104 may be comprised of a steel, plastic, high-strength composite, stainless steel, anti-corrosive material, steel alloy or any other suitable material which can handle the water or other fluid pressure in the system. The pitot gauge transducer 100 may be inserted into the vertical pitot tube 102 for measuring the water pressure. The horizontal pitot tube 104 has a first opening 106 and a second opening 108, and water or fluid may pass from both the first opening 106 and the second opening 108 when the water or fluid pressure is detected by using the pitot gauge transducer 100. The pitot gauge transducer 100 has one or more sensors that are used to detect the pressure of water flow, or leak detection signs when the water flows in the vertical pitot tube 102 and horizontal pitot tube 104. Other sensors may be included, such as temperature 307, alkalinity 308, bacterial 306, chemical 305 and combinations thereof (see e.g., FIG. 3) as this would allow the building owner to test for different factors in the water or fluid simultaneously when collecting the pressure reading.

The wireless pressure transducer 100 measures the pressure of the flowing water or other fluid. It uses a sensor capable of converting the pressure exerted by water or fluid into electrical signals. The pitot gauge transducer 100 is installed in the flow stream and measures the direct pressure at the contact pitot tube hole 101. The measured direct pressure is compared with the static pressure. The difference between the two measurements gives a value for a dynamic pressure. The difference in the level between the liquid in the tube and the free surface becomes the measurement of the dynamic pressure i.e., the actual pressure reading. The vertical pitot tube 102 is a first fluid passageway disposed in a first direction, and the horizontal pitot tube 104 is a second fluid passageway disposed in a second direction, with the second fluid passageway disposed in a different direction from the first fluid passageway.

It should be noted that all the electronic components of the wireless pitot gauge transducer 100 are connected through one or more wired circuits within the wireless pitot gauge transducer 100. The wired circuits are insulated, and are protected from moisture, corrosion, damage and the water or fluid flowing in the vertical pitot tube 102 and horizontal pitot tube 104. The wireless transducer 100 attaches to a hose, pipe or conduit, which attaches to a pump on a commercial building, residential complex or other area. The wireless transducer 100 of the present invention is capable of measuring pressure in the range between 0-300 psi. The wireless transducer 100 is small in size, can provide pressure and temperature readings, and provides readings within 1% accuracy. The details of the sensors and other electronic components will be described in the further figures in detail.

The wireless pitot gauge transducer 100 transmits pressure readings to a software application installed on an electronic device. The wireless gauge 100 eliminates the need to independently manually open and close individual valves for switching back and forth from the different tubes or pipes to read the pressure in each of the pipes.

The wireless pitot gauge 100 may be liquid-filled, similar to a conventional pitot gauge, and may have dial ranges with major and minor graduations. The gauge 100 of the present invention may be tested and certified by the National Institute of Standards and Technology (NIST) to meet the exacting standards of accuracy demanded by clients in the U.S. Navy, Army and aviation industries. The gauge has a smooth interior and a reduced outlet size, which straightens the water stream to allow it to pass generally in a horizontal direction, thereby making the water pressure easier to measure, as it is not subject to increases that may be occasioned by any sort of tortuous paths. The pressure transducer is capable of measuring low differential pressures while operating at the static pressure of the flowing water. The pressure reading output of the pressure transducer is sent to the paired electronic device for long-term studies.

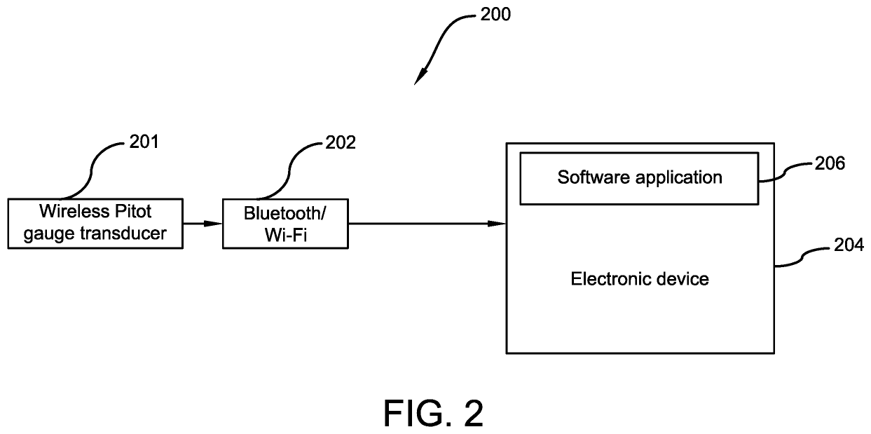

FIG. 2 illustrates a schematic diagram of the connection between one potential embodiment of the wireless pitot gauge transducer 100 of the present invention and a companion mobile application installed on an electronic device in accordance with the disclosed architecture. As shown, a real-time water or fluid pressure reading system 200 has the wireless pitot gauge transducer 100 connected to one or more nearby electronic devices 204 using a wireless communication medium 202 such as Bluetooth, Wi-Fi, building intranet or any other similar wireless technology. The electronic device 204, such as a smartphone device, PDA or laptop has a companion software application 206 which receives real-time pressure readings from the wireless pitot gauge pressure transducer 100, as well as other sensor-based readings, depending on which system configuration has been installed. One or more sensors of the wireless pitot gauge 100 detects the pressure of water flow or leak detection signs when the water flows through the device 100. The wireless pitot gauge transducer 100 detects the water pressure and automatically transmits real-time pressure readings to one or more nearby electronic devices 204, with each having previously installed a software application 206. The pressure reading may have multiple pressure readings of the one or more valves hooked up to, or in communication with, the transducers are hooked up.

It should be appreciated that one or more users may receive real-time pressure readings to their electronic devices via the software application 206. The software application 206 is stored in the computer-readable memory of the electronic device 204. The wireless pitot gauge transducer 100 may be wirelessly coupled to a home water or other fluid-monitoring system in a building or venue, that is supplied with water from a water-supply system. The system may also be used with a pressure bladder such as is used in well-based water supply systems to make sure water is elevated to a proper pressure for distribution throughout the house. The wireless pitot gauge transducer 100 also detects leaks in a pressurized system using the real-time pressure data, as the incoming pressure will show a distinct change from the pressure that is intended to enter the building or other facility.

A smartphone application 206 may be coupled to a plurality of wireless transducers to simultaneously receive multiple readings and take appropriate actions, such as increasing the supply, decreasing the pressure and the like. One or more transducers may also be selected on the software application and the received data may be synched to a central water monitoring system so that water flow can be increased to locations having a low pressure reading.

FIG. 3 illustrates a schematic diagram of various exemplary components of one potential embodiment of the wireless pitot gauge transducer 100 of the present invention in accordance with the disclosed architecture. More specifically, the wireless pitot gauge transducer 100 has a Bluetooth/Wi-Fi transmitter 301 acting as a wireless transceiver, thereby allowing the wireless pitot gauge transducer 100 to connect to one or more nearby paired smartphone devices. The Bluetooth/Wi-Fi transceiver 301 allows the wireless pitot gauge transducer 100 to transmit real-time pressure readings to the paired electronic device, which are displayed in a companion software application installed on the electronic devices. The wireless pitot gauge transducer 100 has a pressure sensor 302 which detects pressure of the water flow flowing through the transducer device. The wireless pitot gauge transducer 100 also has a leak-detection sensor 303 for detecting leaks in a pressurized system, such as a home water system in a building or venue, which is supplied with water from a water-supply system. The wireless pitot gauge transducer 100 may have a small battery 304 for providing power to the components of the wireless pitot gauge transducer 100. Other sensors may be provided such as temperature 307, alkalinity 308, bacterial 306, chemical 305 and combinations thereof.

Furthermore, the wireless pitot gauge transducer 100 may be hooked up to one or more valves and multiple pressure and other sensor readings of the one or more valves can be transmitted simultaneously to a paired electronic device. To measure the flow, the water or fluid flows directly into a pivot tube of the wireless gauge device 100. The pressure of the flowing water is detected by the pressure sensor 302. Pressure of up to 300 psi may be measured by the wireless gauge device 100, and is shown in a graphical and digital format on the companion smartphone application.

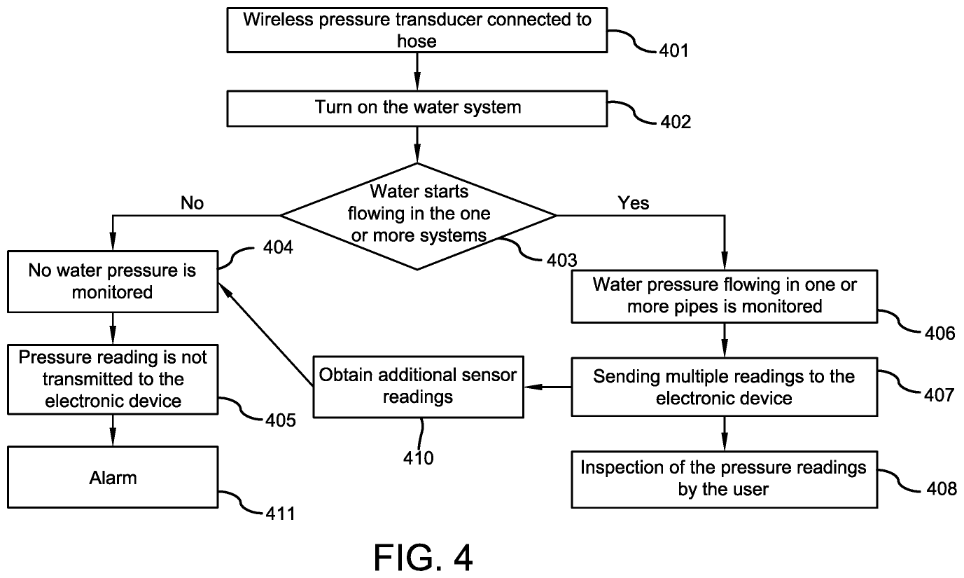

FIG. 4 illustrates a flow diagram showing one potential method of using the wireless pitot gauge transducer 100 of the present invention to generate an alert containing pressure readings in accordance with the disclosed architecture. Initially, a wireless pitot gauge pressure transducer 100 is connected to the one or more hoses which are attached to a water pump or a home water or other fluid system in a building or venue which is supplied with water from a water-supply system (Block 401). The wireless pitot gauge 100 is designed to generate real-time pressure and other sensor readings 410 to the nearby connected electronic devices. Then, the water system is turned on by shutting the one or more valves (Block 402). Thereafter, it is determined if the water starts flowing in the one or more pipelines, hoses or other conduits (Block 403). If the water is not flowing through the wireless pitot gauge transducer from the water system (Block 404), then no pressure readings of the one or more valves are generated and pressure readings are not transmitted to the one or more nearby mobile phones (Block 405), and an alert signal is provided Block 411.

Further, in Block 403, if it is determined that the water starts flowing through the wireless pitot gauge transducer from the water system (Block 406), then real-time pressure readings are generated and transmitted to the one or more paired nearby electronic devices, each having an installed software application (Block 407). The received pressure readings are displayed on the display surface of the electronic device, and can be reviewed by one or more users having the paired electronic devices (Block 408). The received pressure reading on the software application may be in different units such as psi, GPM (Gallons per minute) or other similar units. Other sensor readings are provided in their appropriate units.

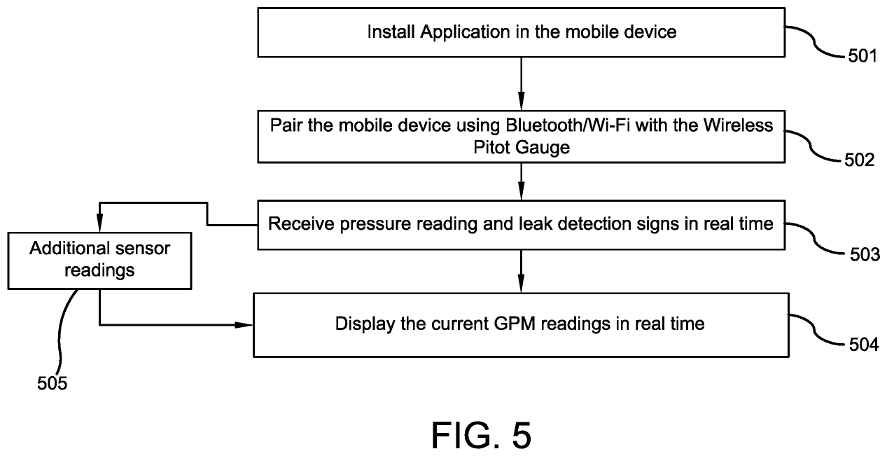

FIG. 5 illustrates a flow diagram showing one potential method of receiving pressure readings from the wireless pitot gauge transducer 100 of the present invention in accordance with the disclosed architecture. Initially, for receiving real-time pressure readings on the electronic device, a user installs the companion software application on an electronic device (Block 501). Then, the electronic device is paired with the wireless pitot gauge pressure transducer 100 using a wireless communication medium such as Bluetooth, Wi-Fi or any other similar wireless technology (Block 502). For pairing on the electronic device, one or more wireless gauge device networks may be selected. For Wi-Fi Direct pairing, the Wi-Fi network of the wireless pitot gauge is selected on the electronic device. For Bluetooth pairing, Bluetooth may be required for authentication. Any other wireless technology, such as infrared, may also be used for connecting the electronic device and the wireless gauge. The Bluetooth/Wi-Fi transmitter allows the pitot gauge wireless device to transmit real-time pressure readings to the electronic device. Then, the one or more paired electronic devices receive the real-time water pressure reading updates, such as leak detection, based on the one or more sensors built in the wireless pitot gauge device (Block 503). The electronic device companion software application displays the real-time pressure readings in different units and scales, and in various graphs and digital values. The received pressure readings are reviewed by one or more users having the paired electronic devices (Block 504) and may also be uploaded to a central server or also to water pipeline maintenance units. The system also provides the additional sensor readings 505 to the paired electronic devices in order achieve the desired monitoring parameters of the building or other venue being considered. The software application may have a plurality of built-in conversion formulae such as PSI to GPM converter, to provide users the readings in various units with a reasonably accurate estimation of actual flow rates.

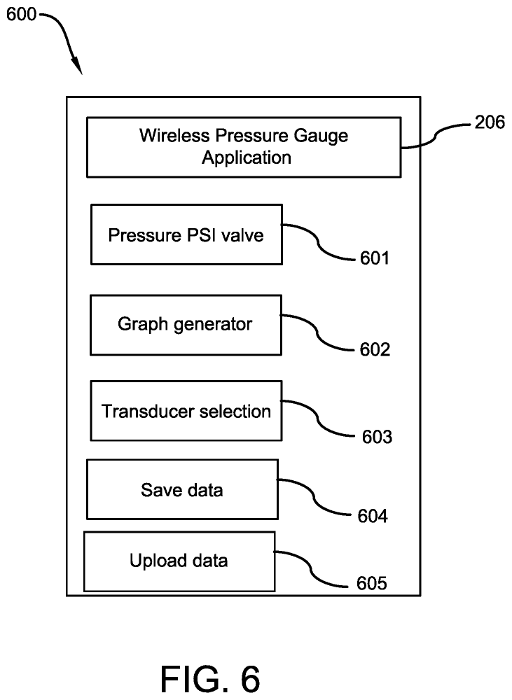

FIG. 6 illustrates a schematic diagram of a graphical user interface of a mobile application on an electronic device in communication with one potential embodiment of the wireless pitot gauge transducer 100 of the present invention in accordance with the disclosed architecture. More specifically, the graphical and textual user interface 600 of the software application 206 displays the real-time pressure readings from one or more wireless pressure transducers. The graphical user interface 600 may display real-time pressure reading of one or more valves in a psi scale 601. As known in the art, one psi is the pressure resulting from a force of one pound-force applied to an area of one square inch. In SI units, 1 psi is approximately equal to 6895 N/m. Other units, such as GPM, bar, etc., may also be used for displaying the recorded pressure values. The software application 206 has a graph generator 602 to generate and display graphical and textual representation of the real-time pressure readings of one or more valves. The graphical user interface 600 offers a transducer selection 603 header which allows a user to select one particular wireless pitot gauge pressure transducer for monitoring real time pressure readings. The graphical user interface 600 has a “Save header” 604, which the individual monitoring the facility may use to store the readings in the software application 206. The real-time pressure readings will be stored in the electronic device having the companion software application 206 for future analysis. An upload header 605 may allow the user to upload the real-time pressure readings on a cloud-based data storage, such as a public cloud or a private cloud storage.

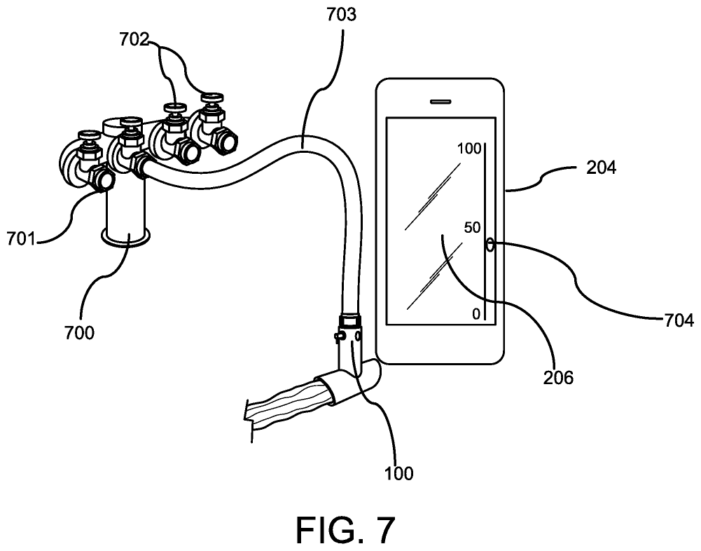

FIG. 7 illustrates a perspective view of one potential embodiment of the wireless pitot gauge transducer 100 of the present invention in accordance with the disclosed architecture, wherein the fluid pressure gauge is being used to gather and display real-time pressure readings from a line. As shown, a wireless pitot gauge transducer 100 is connected to the water system 700 through a pipe 703. The water system 700 may be a water pump or a home water system in a building or venue that is supplied with water from a water-supply system. The wireless pitot gauge pressure transducer 100 is connected to the one or more hose(s), pipe(s) or conduit(s) 701 of the water or fluid supply system 700. The water system 700 has one or more valves 702 to control flow of water in the wireless pitot gauge pressure transducer 100 through the pipe 703. The pipe 703 may be made of plastic, steel or any other suitable material. When the water or fluid starts flowing through the wireless pitot gauge pressure transducer 100 through pipe 703, the wireless pitot gauge pressure transducer 100 generates real time pressure readings 704, and transmits the real-time pressure readings 704 to the electronic device(s) 204 having the companion software application 206. The electronic device 204 companion software application 206 receives the real-time pressure reading 704 and other readings that may be selected based on the capabilities of the system. The companion software application 206 displays real-time pressure reading(s) 704 on various scales and in a graphical format.

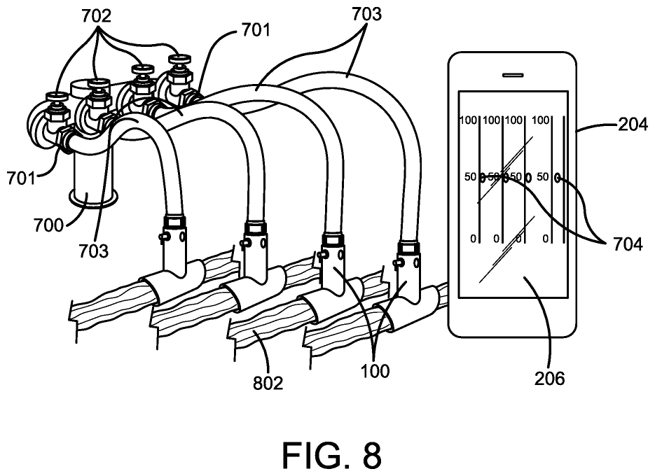

FIG. 8 illustrates a perspective view of one potential embodiment of a plurality of wireless pitot gauge transducers 100 of the present invention in accordance with the disclosed architecture, wherein the wireless pitot gauge transducers 100 are being used to gather and display real-time pressure readings from a corresponding number of lines. As shown, one or more wireless pitot gauge transducers 100 may be connected to one or more hose(s) 701 of the water system 700. The water system 700 may be a water pump or a home-water system in a building or venue that is supplied with water from a water-supply system. The water system 700 has one or more valves 702 to control the flow of water or other fluid 802 in the wireless pitot gauge pressure transducer 100 through one or more pipes 703. The one or more pipes 703 may be made of plastic, steel, metal alloys, composite materials or any other suitable material which may meet the building code requirements where the building is located.

When the water or fluid 802 starts flowing through the one or more wireless pitot gauge pressure transducers 100 through the respective pipe(s) 703, the one or more wireless pitot gauge pressure transducers 100 generate real-time pressure readings 704 of the one or more valves 702. The one or more wireless pitot gauge pressure transducers 100 transmit the real-time pressure readings 704 to the electronic device 204 having a previously installed companion software application 206. The companion software application 206 receives the one or more real-time pressure or other reading(s) 704 of the one or more valves 702 of the water system 700. The companion software application 206 displays one or more real-time pressure reading(s) along with graphical and textual representation. The device 100 of the present invention provides an easy, time-effective and cost-effective solution of monitoring water pressure by providing a report to customers to retain for their records. A user does not have to manually test the water flow, and the device 100 eliminates the need to open and close valves for switching back and forth from tubes or pipes to read pressure. The wireless pitot gauge is a ¼ pressure transducer or transmitter to send readings to a software application.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “wireless pitot gauge transducer”, “water pressure transducer”, “pressure transducer”, “pitot gauge transducer”, and “wireless pitot gauge pressure transducer” are interchangeable and refer to the wireless fluid pressure gauge 100 of the present invention.

Notwithstanding the forgoing, the wireless fluid pressure gauge 100 of the present invention can be of any suitable size and configuration as is known in the art without affecting the overall concept of the invention, provided that it accomplishes the above-stated objectives. One of ordinary skill in the art will appreciate that the size, configuration and material of the wireless fluid pressure gauge 100 as shown in the FIGS. are for illustrative purposes only, and that many other sizes and shapes of the wireless fluid pressure gauge 100 are well within the scope of the present disclosure. Although the dimensions of the wireless fluid pressure gauge 100 are important design parameters for user convenience, the wireless fluid pressure gauge 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fluid gauge system comprising:
a fluid gauge having a housing, wherein the housing comprises a first fluid passageway disposed in a first direction and a second fluid passageway disposed in a second direction that is distinct from the first direction;
the housing is constructed of a material to withstand pressure of a fluid traveling through the first and second fluid passageways;
a first sensor disposed in one of the first and second fluid passageways; and
a wireless transmitter for transmitting an information collected from the first sensor.

2. The fluid gauge system as recited in claim 1 further comprising a smart device having a smart application for receiving the information collected from the first sensor and transmitted by the wireless transmitter.

3. The fluid gauge system as recited in claim 2, wherein the smart device is at a location remote from the fluid gauge.

4. The fluid gauge system as recited in claim 1 further comprising at least one additional sensor for recording information of a fluid traveling through one of the first and second fluid passageways.

5. The fluid gauge system as recited in claim 4, wherein the at least one additional sensor is selected from a group consisting of a temperature sensor, an alkalinity sensor, a bacterial sensor, a chemical sensor and a leak detection sensor.

6. The fluid gauge system as recited in claim 4, wherein the at least one additional sensor is a leak detection sensor.

7. The fluid gauge system as recited in claim 2, wherein the smart device displays the information in a graphical and a textual representation format.

8. The fluid gauge system as recited in claim 1, wherein the first direction is generally perpendicular to the second direction.

9. The fluid gauge system as recited in claim 1, wherein the pressure ranges between 0-300 psi.

10. The fluid gauge system as recited in claim 1 further comprising a battery for powering the first sensor and the wireless transmitter.

11. The fluid gauge system as recited in claim 7, wherein the smart device displays the information in real-time as it is received from the wireless transmitter.

12. A pitot system for connection to a standpipe comprising:
a least one pipe connected to a standpipe;
a pitot having a housing including a first fluid passageway and a second fluid passageway, wherein the first and second fluid passageways are disposed in a generally perpendicular orientation to one another;
a pressure transducer provided in the housing;
a water pressure sensor;
a leak detection sensor; and
a wireless transmitter in communication with each of the pressure sensor and the leak detection sensor.

13. The pitot system as recited in claim 12 further comprising a smart device having an application for displaying an information transmitted from the wireless transmitter.

14. The pitot system as recited in claim 13, wherein the smart device displays the information in real time in a textual and a graphical representation.

15. The pitot system as recited in claim 12 further comprising at least one additional sensor selected from a group consisting of a temperature sensor, an alkalinity sensor, a bacterial sensor and a chemical sensor.

16. The pitot system as recited in claim 12, wherein the pressure transducer and the pressure sensor measure a pressure ranging between 0-300 psi.

17. The pitot system as recited in claim 12, wherein the leak detection sensor comprises an alarm.

18. A method of using a pitot for collecting a fluid system readings, the method comprising the steps of;
providing the pitot comprised of a housing having a first fluid passageway and a second fluid passageway, wherein the first and second fluid passageways are disposed in a generally perpendicular orientation to one another;
connecting the pitot to a fluid inlet of a building, a venue or a complex to be monitored;
turning on a fluid to be monitored;
detecting a pressure of the fluid in the housing of the pitot;
collecting information relating to the pressure; and
transmitting the information to smart device.

19. The method as recited in claim 18, wherein the pitot includes a sensor selected from a group including a water pressure sensor, leak detection sensor, a temperature sensor, alkalinity sensor, bacterial sensor, a chemical sensor and a combination thereof.

20. The method as recited in claim 18 comprising a further step of generating an alarm after the step of collecting where the fluid has a pressure less than anticipated.
